(19) United States
(12) Patent Application Publication
(10) Pub. No.: US 2023/0167349 A1
(43) Pub. Date: Jun. 1, 2023

(54) Wellbore Servicing Fluid and Methods of Making and Using Same

(71) Applicant: Halliburton Energy Services, Inc., Houston, TX (US)

(72) Inventors: Nivika Rajendra GUPTA, Pune (IN); Akashdeep Singh JAMWAL, Pune (IN); Jeffrey J. MILLER, Houston, TX (US)

(21) Appl. No.: 17/537,085

(22) Filed: Nov. 29, 2021

(51) Int. Cl. C09K 8/28

(52) U.S. Cl. CPC C09K 8/28

(57) ABSTRACT

Disclosed herein is a wellbore servicing fluid including an aqueous fluid, an oil, and a compound according to Structure I or Structure II. The wellbore servicing fluid can be used as a drilling fluid in a method of servicing a wellbore penetrating a subterranean formation. The wellbore servicing fluid can have an increased emulsion stability, a reduced dilution and waste volume, and can reduce fluid loss and/or salt washout when drilling though certain subterranean formations such as salt domes.

### FIELD

This application relates to a composition, and more specifically this application relates to a wellbore servicing fluid that can be used in the recovery of natural resources from a wellbore penetrating a subterranean formation.

### BACKGROUND

This disclosure relates generally to a composition. More specifically, it relates to a wellbore servicing fluid and methods of making and using same for treating a wellbore penetrating a subterranean formation, for example during a drilling operation.

Hydrocarbons, such as oil and gas, residing in a subterranean formation or zone are usually recovered by drilling a wellbore down to the subterranean formation while circulating a drilling fluid in the wellbore. The drilling fluid is usually circulated downward through the interior of the drill pipe and upward through the annulus, which is located between the exterior of the drill pipe and the interior wall of the wellbore. Among other functions, the drilling fluid may serve to transport wellbore cuttings up to the surface, cool the drill bit, and provide hydrostatic pressure on the walls of the drilled wellbore.

Drilling fluid density may be an important factor to monitor during drilling operations as the hydrostatic pressure exerted by the drilling fluid is directly proportional to the density of the drilling fluid. Hydrostatic pressure would increase with increasing density of the drilling fluid and height of fluid column. Excess hydrostatic pressure above the fracture gradient of the formation may lead to premature fracturing of the formation and resultant formation damage and fluid loss. To remedy these and other issues, oil may be added to an aqueous drilling fluid to reduce the density but these systems may not be stable at static conditions. Such oil and water systems may stratify rapidly, even when an emulsifier is used. Furthermore, these systems may become increasingly unstable at a higher salinity such as in brine-based drilling fluids, which may not be well suited for storing for an extended period and may require additional surface equipment to prepare and use.

Therefore, an ongoing need exists for a drilling fluid with lower density and increased stability, especially when the drilling fluid includes salts.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a schematic diagram of an example drilling assembly.

FIGS. 2A and 2B are photos of samples after hot rolling in accordance with some aspects of the disclosure.

FIGS. 3A and 3B are photos of samples after static aging in accordance with some aspects of the disclosure.

### DETAILED DESCRIPTION

It should be understood at the outset that although an illustrative implementation of one or more aspects are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

It is to be understood that “subterranean formation” encompasses both areas below exposed earth and areas below earth covered by water such as ocean or fresh water. Herein in the disclosure, “top” means the well at the surface (e.g., at the wellhead which may be located on dry land or below water, e.g., a subsea wellhead), and the direction along a wellbore towards the well surface is referred to as “up”; “bottom” means the end of the wellbore away from the surface, and the direction along a wellbore away from the wellbore surface is referred to as “down.” For example, in a horizontal wellbore, two locations may be at the same level (i.e., depth within a subterranean formation), the location closer to the well surface (by comparing the lengths along the wellbore from the wellbore surface to the locations) is referred to as “above” the other location, the location farther away from the well surface (by comparing the lengths along the wellbore from the wellbore surface to the locations) is referred to as “below” or “lower than” the other location.

Disclosed herein is a wellbore servicing fluid. The wellbore servicing fluid can be a direct emulsion fluid, which may also be referred to as an oil-in-water emulsion. A characteristic of a direct emulsion fluid may be that the aqueous phase of the emulsion is the external phase or the continuous phase while the oil phase is the internal phase or the dispersed phase. The direct emulsion fluid may be used during a wellbore drilling operation to aid in the creation and extension of a wellbore through a subterranean formation. Generally, it may be desirable to keep the subterranean formation in a water-wet condition where a thin film of water may coat the surface of the subterranean formation matrix. A water-wet condition may allow for more efficient hydrocarbon transport than where the subterranean formation is in an oil-wet condition. A direct emulsion fluid may provide certain benefits to drilling in formations where a relatively lower density drilling fluid is desired. A direct emulsion fluid may be mixed to a variety of densities appropriate for a particular application.

The wellbore servicing fluid disclosed herein can include an aqueous fluid, an oil, and a compound according to Structure I or Structure II:

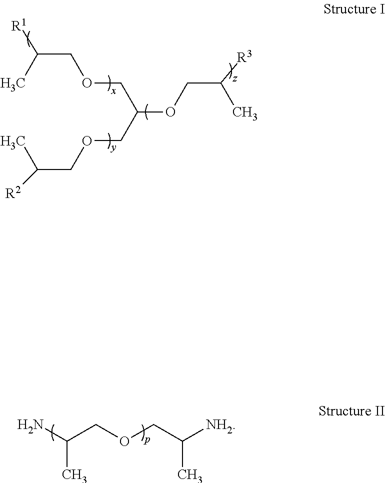

In aspects, R¹, R², and R³ are independently selected from the group including —NH₂, —NR⁷R⁸, —H, —OH, halo, straight or branched (C₁-C₆)alkyl, straight or branched (C₂-C₆)alkenyl, straight or branched (C₂-C₆)alkynyl, (C₆-C₁₄)aryl, (C₃-C₁₄)-cycloalkyl, (C₆-C₁₄)aryl-(C₁-C₆)alkylene-, (5-14-membered)heteroaryl-(C₁-C₆)alkylene-, (5-14-membered)heteroaryl, (3-14-membered)heterocycloalkyl, (3-14-membered)heterocycloalkyl-(C₁-C₆)alkylene-, (5-14-membered)heteroaryl-(3-14-membered)heterocycloalkylene-, (C₆-C₁₄)aryl-(3-14-membered)heterocycloalkylene-, (C₆-C₁₄)aryl-(C₁-C₆)alkyl-(3-14-membered)heterocycloalkylene-, (5-14-membered)heteroaryl-(C₁-C₆)alkyl-(3-14-membered)heterocycloalkylene-, and (3-14-membered)heterocycloalkyl-(C₁-C₆)alkyl-(3-14-membered)heterocycloalkylene-.

R⁷ and R⁸ can be independently selected from the group including straight or branched (C₁-C₆)alkyl, straight or branched (C₂-C₆)alkenyl, straight or branched (C₂-C₆)alkynyl, (C₆-C₁₄)aryl, (C₃-C₁₄)-cycloalkyl, (C₆-C₁₄)aryl-(C₁-C₆)alkylene-, (5-14-membered)heteroaryl-(C₁-C₆)alkylene-, (5-14-membered)heteroaryl, (3-14-membered)heterocycloalkyl, (3-14-membered)heterocycloalkyl-(C₁-C₆)alkylene-, (5-14-membered)heteroaryl-(3-14-membered)heterocycloalkylene-, (C₆-C₁₄)aryl-(3-14-membered)heterocycloalkylene-, (C₆-C₁₄)aryl-(C₁-C₆)alkyl-(3-14-membered)heterocycloalkylene-, (5-14-membered)heteroaryl-(C₁-C₆)alkyl-(3-14-membered)heterocycloalkylene-, and (3-14-membered)heterocycloalkyl-(C₁-C₆)alkyl-(3-14-membered)heterocycloalkylene-.

In some aspects, at least one of R¹, R², and R³ is —NH₂. In some aspects, x+y+z is from about 70 to about 100, alternatively from about 75 to about 95, or alternatively from about 80 to about 90. In one or more aspects, each of R¹, R², and R³ are —NH₂ and x+y+z is about 85.

The compound of structure I can have a molecular weight from about 4,000 Daltons (Da) to about 6,000 Da, alternatively from about 4,500 Da to about 5,500 Da, or alternatively from about 4,250 Da to about 4,750 Da.

In some aspects, p is from about 3 to about 40, alternatively from about 3 to about 35, or alternatively from about 3 to about 30. The compound of structure II can have a molecular weight of from about 220 Da to about 2,000 Da, alternatively from about 250 Da to about 1,800 Da, or alternatively from about 250 Da to about 1,750 Da.

The compound can be in a form of a liquid. In some aspects, the compound is present in the wellbore servicing fluid in an amount of from about 0.5 pounds per barrel (ppb) to about 10 ppb, alternatively from about 0.5 ppb to about 8 ppb, alternatively from about 0.5 ppb to about 6 ppb, or alternatively from about 0.5 ppb to about 4 ppb.

The compound can be multi-functional. In aspects, the compound operates as an emulsifier, which increases stability of a direct emulsion fluid (e.g., the wellbore servicing fluid) by reducing interfacial tension between water and oil. In one or more aspects, the compound operates as a corrosion inhibitor and/or a shale inhibitor. A corrosion inhibitor is to protect metal (e.g., iron and steel) components in the wellbore and treating equipment from a fluid. A shale inhibitor can reduce swelling of sensitive shales and drill cuttings exposed to drilling fluids.

In one or more aspects, the wellbore servicing fluid includes an oil. Examples of suitable oils that may be included in the wellbore servicing fluid may include, but are not limited to at least one oil selected from the group including alkanes, olefins, alkynes, aromatics, tall oil, crude oil, light cycle oil, synthetic ester oil, diesel, cycloalkane, liquefied petroleum gas, kerosene, gas oil, fuel oil, paraffin oil, mineral oil, refined oil, low-toxicity mineral oil, ester, amide, synthetic oil, polydiorganosiloxane, siloxane, organosiloxane, ether, dialkylcarbonate, vegetable oil, biodiesel, renewable diesel, and combinations thereof. In one or more aspects, the oil includes a synthetic oil.

In some aspects, the oil is present in the wellbore servicing fluid in an amount of from about 1 vol. % to about 40 vol. %, based on the total volume of the wellbore servicing fluid, alternatively from about 5 vol. % to about 40 vol. %, or alternatively from about 5 vol. % to about 35 vol. %.

The wellbore servicing fluid can include an aqueous fluid. Generally, the aqueous fluid may be from any source, provided that it does not contain an amount of components that may undesirably affect the other components in the wellbore servicing fluid. For example, the aqueous fluid can be selected from a group including essentially of fresh water, surface water, ground water, produced water, salt water, sea water, brine (e.g., underground natural brine, formulated brine, etc.), and combinations thereof. In some aspects, the aqueous fluid includes a brine. In one or more aspects, the brine includes monovalent or divalent salts such as, without limitation, at least one salt selected from the group including sodium chloride, sodium bromide, potassium bromide, potassium chloride, magnesium chloride, calcium chloride, calcium bromide, potassium formate, cesium formate, lithium chloride, lithium bromide, sodium formate, lithium formate, ammonium chloride, tetramethyl ammonium chloride, choline chloride, potassium acetate, and combinations thereof. A formulated brine may be produced by dissolving one or more soluble salts in water, a natural brine, or sea water.

The brine can be a saturated or an unsaturated brine. The salt may be present in the brine in any amount to form a saturated solution or supersaturated solution. For example, the salt may be included in an amount of about 1% to about 50% by weight of the brine. Alternatively, about 1% to about 5% by weight, about 5% to about 10% by weight, about 10% to about 15% by weight, about 15% to about 20% by weight, about 20% to about 25% by weight, about 25% to about 30% by weight, about 30% to about 35% by weight, about 35% to about 40% by weight, about 40% to about 45% by weight, about 45% to about 50/o by weight, or about 100/to about 30% by weight. The brine can reduce dilution and/or volume of the wellbore servicing fluid, thus reduces waste volumes.

The aqueous fluid can be present in the wellbore servicing fluid in an amount effective to provide a pumpable slurry, such as a slurry having desired (e.g., job or service specific) rheological properties. In aspects, the aqueous fluid is present in the wellbore servicing fluid in an amount of from about 50 vol. % to about 99 vol. % based on the total volume of the wellbore servicing fluid, alternatively from about 50 vol. % to about 95 vol. %, or alternatively from about 50 vol. % to about 90 vol. %.

The density of a particular wellbore servicing fluid may be directly affected by the volume ratio of oil to aqueous fluid, generally referred to herein as oil-to-water or “O/W”, in the wellbore servicing fluid. The aqueous fluid may be present as the continuous phase while the oil may be in the dispersed phase. Any suitable ratio of oil-to-water may be used to form the wellbore servicing fluid to achieve any desired density. For example, the O/W ratio may be 90:10 to 20:80. Alternatively, the O/W ratio may be 90:10 to 80:20, 80:20 to 70:30, 70:30 to 60:40; 60:40 to 50:50, 50:50 to 40:60, 40:60 to 30:70, or 30:70 to 20:80.

For volumes of oil above 50%, the wellbore servicing fluid may still be considered a direct emulsion even though the volume of oil may be present in an amount greater than the water because the compound allows the water to remain at the continuous phase thereby keeping the wellbore servicing fluid water-wetting.

In one or more aspects, the wellbore servicing fluid further includes a viscosifier. The viscosifier can include a biopolymer, a synthetic polymer, minerals, or a combination thereof. The minerals can include sepiolite, attapulgite, bentonite, sodium bentonite, montmorillonite, beidellite, nontronite, hectorite, samonite, smectite, kaolinite, serpentine, illite, chlorite, montmorillonite, saponite, fuller's earth, attapulgite, laponite, or combinations thereof. In some aspects, the viscosifier includes hydroxyethyl cellulose, hydroxy-propyl guar, carboxy-methyl-hydroxy-propyl guar, modified polysaccharides, partially hydrolyzed polyacrylamide (PHPA), carboxy-methylcellulose, polyanionic cellulose, guar gum, locust bean gum, Karaya gum, gum tragacanth, hydrophobically modified guars, high-molecular weight polysaccharides composed of mannose and galactose sugars, heteropolysaccharides obtained by the fermentation of starch-derived sugars, xanthan, pectins, diutan, welan, gellan, scleroglucan, chitosan, dextran, substituted or unsubstituted galactomannans, starch, cellulose, cellulose ethers, carboxycelluloses, hydroxypropyl cellulose, carboxyalkylhydroxyethyl celluloses, carboxymethyl hydroxyethyl cellulose, methyl cellulose, sodium polyacrylate, polyacrylamide, partially hydrolyzed polyacrylamide, polymethacrylamide, poly(acrylamido-2-methyl-propane sulfonate), poly(sodium-2-acrylamide-3-propylsulfonate), copolymers of acrylamide and acrylamido-2-methyl-propane sulfonate, terpolymers of acrylamido-2-methyl-propane sulfonate, acrylamide and vinylpyrrolidone or itaconic acid, sepiolite, attapulgite, or combinations thereof.

In aspects, the viscosifier has a number average molecular weight in a range of from about 1.2 MM Da to about 5 MM Da, alternatively from about 1.5 MM Da to about 4.5 MM Da, or alternatively from about 2 MM Da to about 4 MM Da.

In one or more aspects, the viscosifier is in the wellbore servicing fluid in an amount of from about 0.001 wt. % to about 3 wt. %, based on the total weight of the wellbore servicing fluid, alternatively from about 0.01 wt. % to about 2.5 wt. %, or alternatively from about 0.1 wt. % to about 2.0 wt. %.

In aspects, the wellbore servicing fluid further includes one or more additives. The one or more additives can include a rate of penetration enhancer, spotting fluid, a sweeping agent, a deflocculant, a degreaser, a pH buffer, a wetting agent, a lubricant, a shale inhibitor, a friction reducer, a strength-stabilizing agent, an emulsifier, an expansion agent, a salt, a fluid loss agent, a vitrified shale, a thixotropic agent, a dispersing agent, a weight reducing additive (e.g., hollow glass or ceramic beads), a heavyweight additive, a surfactant, a scale inhibitor, a clay stabilizer, a silicate-control agent, a biocide, a biostatic agent, a storage stabilizer, a filtration control additive, a suspending agent, a foaming surfactant, latex emulsions, a formation conditioning agent, elastomers, gas/fluid absorbing materials, resins, superabsorbers, mechanical property modifying additives (i.e. carbon fibers, glass fibers, metal fibers, minerals fibers, polymeric elastomers, latexes, etc.), inert particulates, a biopolymer, a polymer, a fume silica, a free fluid control additive, particulate materials, acids, bases, mutual solvents, corrosion inhibitors, conventional breaking agents, relative permeability modifiers, lime, clay control agents, fluid loss control additives, flocculants, water softeners, foaming agents, oxidation inhibitors, thinners, scavengers, gas scavengers, lubricants, bridging agents, a foam stabilizer, catalysts, dispersants, breakers, emulsion thinner, emulsion thickener, pH control additive, lost circulation additives, buffers, stabilizers, chelating agents, oxidizers, a clay, reducers, consolidating agent, complexing agent, sequestration agent, control agent, an oxidative breaker, and the like, or combinations thereof. The oxidative breaker can include bromate, persulfate, perborate, and perbromate, for example. With the benefit of this disclosure, one of ordinary skill in the art should be able to recognize and select one or more suitable optional additives for use in the wellbore servicing fluid.

In aspects, the one or more additives are present in the wellbore servicing fluid in an amount of from about 0.001 wt. % to about 50 wt. %, based on the total weight of the wellbore servicing fluid, alternatively from about 0.1 wt. % to about 50 wt. %, or alternatively from about 1 wt. % to about 40 wt. %.

Plastic viscosity is the viscosity when extrapolated to infinite shear rate, e.g., the slope of the shear stress/shear rate line above yield point. The yield point refers to the resistance of a fluid to initial flow, or represents the stress required to start fluid movement. The wellbore servicing fluid disclosed herein can have any suitable plastic viscosity and yield point. At about 30° F. to about 180° F. the wellbore servicing fluid can have a plastic viscosity of from about 1 cP to about 500 cP, alternatively from about 1 cP to about 400 cP, or alternatively from about 1 cP to about 300 cP. At about 120° F. the wellbore servicing fluid can have a plastic viscosity of from about 1 cP to about 80 cP, alternatively from about 1 cP to about 70 cP, or alternatively from about 1 cP to about 60 cP. At about 30° F. to about 180° F. the wellbore servicing fluid can have a yield point of from about 1 lbs/100 ft² to about 100 lbs/100 ft², alternatively from about 2 lbs/100 ft² to about 90 lbs/100 ft², alternatively from about 3 lbs/100 ft² to about 80 lbs/100 ft², or alternatively from about 5 lbs/100 ft² to about 70 lbs/100 ft. The Plastic viscosity and Yield point can be calculated using Bingham Plastic model.

At about 30° F. to about 180° F. the wellbore servicing fluid can have a 10-second gel strength of from about 1 lbs/100 ft² to about 50 lbs/100 ft², alternatively from about 2 lbs/100 ft² to about 50 lbs/100 ft², alternatively from about 3 lbs/100 ft² to about 40 lbs/100 ft², or alternatively from about 5 lbs/100 ft² to about 40 lbs/100 ft². At about 30° F. to about 180° F. the wellbore servicing fluid can have a 10-minute gel strength of from about 1 lbs/100 ft² to about 50 lbs/100 ft², alternatively from about 2 lbs/100 ft² to about 50 lbs/100 ft, alternatively from about 3 lbs/100 ft² to about 40 lbs/100 ft², or alternatively from about 5 lbs/100 ft² to about 40 lbs/100 ft.

The wellbore servicing fluid disclosed herein can have any suitable value of pH. In aspects, the wellbore servicing fluid has a pH of from about 7 to about 11 at room temperature (about 70° F.), alternatively from about 7 to about 10.5, or alternatively from about 8 to about 10.

The wellbore servicing fluid can have a total fluid loss of from about 0 mL to about 20 mL per 30 minutes, when measured in accordance with test standard API-RP-10B-2. Alternatively, the total fluid loss is from about 0 mL to about 15 mL per 30 minutes, alternatively from about 0 mL to about 10 mL per 30 minutes, or alternatively from about 0 mL to about 7 mL per 30 minutes.

In some aspects, the total fluid loss includes an oil layer in an amount of from about 0 mL to about 10 mL per 30 minutes, alternatively from about 0 mL to about 7 mL per 30 minutes, or alternatively from about 0 mL to about 5 mL per 30 minutes. The oil layer includes oil that is separated from the wellbore servicing fluid in the fluid loss test. The oil layer can also be referred to as “oil in API filtrate” herein.

In some aspects, hot rolling is performed to the wellbore servicing fluid at about 160° F. for about 16 hours to about 24 hours. In some other aspects, the wellbore servicing fluid undergoes static aging at about 160° F. for about 24 hours. The wellbore servicing fluid can have a rheology reading of from about 3 to about 200 at about 120° F. to about 150° F., atmospheric pressure, and 3 rpm to 600 rpm, alternatively from about 3 to about 150, alternatively from about 4 to about 100, or alternatively from about 5 to about 90, when measured in accordance with test standard API-RP-10B-2 before and after the hot rolling, and after the static aging. In one or more aspects, the wellbore servicing fluid has a rheology reading of from about 3 to about 20 at about 120° F. to about 150° F., atmospheric pressure, and 3 rpm to 6 rpm, alternatively from about 3 to about 15, alternatively from about 4 to about 15, or alternatively from about 5 to about 15, when measured in accordance with test standard API-RP-10B-2 before and after the hot rolling, and after the static aging.

In a fluid or a slurry, settling of particles is referred to as “sag”. A sag test can be performed to determine a sag factor of a fluid or a slurry. A lower sag factor indicates increased fluid stability against particle sedimentation. In some aspects, the wellbore servicing fluid has a sag factor of from about 0.50 to about 0.53, when measured in accordance with test standard API-RP-13B-2, alternatively from about 0.50 to about 0.52, or alternatively from about 0.50 to about 0.515.

In one or more aspects, the wellbore servicing fluid has a top oil separation of equal to or less than about 4% based on the total volume of the wellbore servicing fluid in a sag test after static aging for about 24 hours at about 160° F., when measured in accordance with test standard API-RP-13B-2. Alternatively, the top oil separation is equal to or less than about 3%, alternatively equal to or less than about 2%, or alternatively equal to or less than about 1%.

The wellbore servicing fluid disclosed herein can have any suitable density, including, but not limited to, in a range of from about 4 lb/gal (ppg) to about 25 ppg, alternatively from about 7 ppg to about 20 ppg, alternatively from about 10 ppg to about 20 ppg, or alternatively from about 12 ppg to about 18 ppg. In one or more aspects, the density can be reduced by various methods, such as adding hollow microspheres, low-density elastic beads, or other density-reducing additives known in the art. In some aspects, the density may be reduced during production of the wellbore servicing fluid prior to placement in a subterranean formation.

In one or more aspects, the wellbore servicing fluid has an electrical stability reading of from about 0 volts to about 5 volts, alternatively from about 1 volt to about 4 volts, or alternatively from about 1 volt to about 3 volts. The electrical stability indicates emulsion and oil-wetting qualities of a slurry, and can be measured in accordance to test standard API-RP-13B-2.

A wellbore servicing fluid of the type disclosed herein can be prepared using any suitable method, such as batch mixing or continuous mixing. In one or more aspects, the method includes mixing components (e.g., the aqueous fluid, the oil, the compound, and optional one or more additives) of the wellbore servicing fluid using mixing equipment (e.g., a jet mixer, re-circulating mixer, a batch mixer, a blender, a mixing head of a solid feeding system) to form a pumpable slurry (e.g., a homogeneous fluid). For example, all components of the wellbore servicing fluid may be added to a batch mixer and agitated until the desired amount of mixing is achieved. Alternatively, the wellbore servicing fluid may be added to a continuous mixer where components are metered in and a product of the wellbore servicing fluid is continuously withdrawn. The compound can be added as a single component while performing one or more functions (e.g., an emulsifier, a corrosion inhibitor), which reduces the time of preparation of the wellbore servicing fluid. The wellbore servicing fluid may be mixed at elevated temperatures to aid in blending of the components and to produce a wellbore servicing fluid with desired viscosity, and other fluid properties. For example, the wellbore servicing fluid may be prepared at a temperature range of about 150° F. to about 200° F., about 150° F. to about 165° F., about 165° F. to about 175° F., or from 175° F. to about 200° F.

In some aspects, a portion of the components of the wellbore servicing fluid is from an existing treating fluid, such as a treating fluid recovered from the same or another well. Additional components (e.g., an aqueous fluid, an oil, the compound, one or more additives) can be added to the recovered treating fluid to prepare the wellbore servicing fluid disclosed herein.

In aspects, the wellbore servicing fluid is used as a drilling fluid. In drilling operations, the wellbore servicing fluid can be placed (e.g., pumped) into a wellbore. A method of servicing a wellbore penetrating a subterranean formation can include providing a wellbore servicing fluid of the type disclosed herein and circulating the wellbore servicing fluid from a surface (e.g., a well site) through a wellbore. The wellbore servicing fluid can be circulated back to the surface. In one or more aspects, the method further includes extending the wellbore in the subterranean formation while circulating the wellbore servicing fluid. The wellbore servicing fluid may be circulated through a drill string and bottom hole assembly. The wellbore servicing fluid may transfer kinetic energy into a mud motor to drive a drill bit on the end of the bottom hole assembly thereby extending the wellbore.

In one or more aspects, the wellbore has a Bottombole Static Temperature (BHST) of from about 50° F. to about 300° F., alternatively from about 50° F. to about 275° F., alternatively from about 50° F. to about 250° F., alternatively from about 50° F. to about 225° F., or alternatively from about 50° F. to about 200° F.

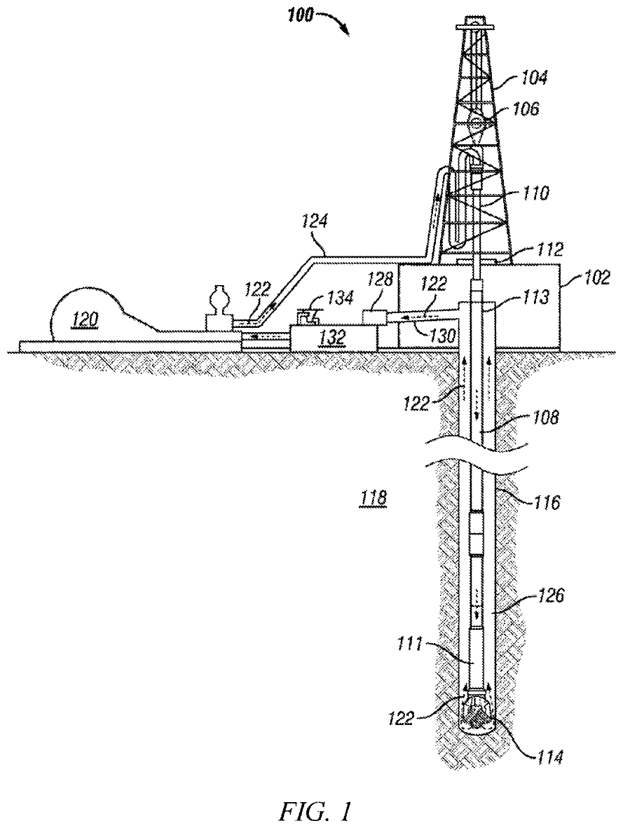

As will be further described in FIG. 1 below, the wellbore servicing fluid may be generally cleaned and reused throughout a drilling operation. The wellbore servicing fluid may be cleaned of solids and drill cuttings and recycled back into the drill string. The additional oil or aqueous fluid may be added at any time during the fluid handling process to increase or decrease the density. For example, without limitation, the additional oil or aqueous fluid may be added in an inline mixer, to storage tanks including the wellbore servicing fluid, in the mud pit, or any other point in the fluid handling system.

Drilled solids which become entrained in the fluid may be removed by various means which are well known in the art. Shale shakers with select screen mesh sizes are often the most widely-used separation tools. These can be augmented with centrifuges having varying spool/bowl sizes and rotational speeds to further remove fine solids. Separation of solids by these means will allow for additional use of a given fluid, with lower requirements for liquid dilution to keep a constant density.

FIG. 1 illustrates an exemplary drilling assembly 100 in which a drilling fluid 122, such as a wellbore servicing fluid disclosed herein, may be used. It should be noted that while FIG. 1 generally depicts a land-based drilling assembly, the principles described herein are equally applicable to subsea drilling operations that employ floating or sea-based platforms and rigs, without departing from the scope of the disclosure.

As illustrated, the drilling assembly 100 may include a drilling platform 102 that may support a derrick 104 having a traveling block 106 for raising and lowering a drill string 108, wherein the drill string 108 may have a proximal end 113 and a distal end 111. The drill string 108 may include, but is not limited to, drill pipe and coiled tubing, as generally known to those skilled in the art. A kelly 110 may support the drill string 108 as it is lowered through a rotary table 112. A drill bit 114 may be attached to the distal end 111 of the drill string 108, wherein the drill bit 114 may be driven either by a downhole motor and/or via rotation of the drill string 108 from the well surface. The drill bit 114 may include, but is not limited to, roller cone bits, polycrystalline diamond compact (PDC) bits, natural diamond bits, any hole openers, reamers, coring bits, etc. As the drill bit 114 rotates, it may create a wellbore 116 that may penetrate various subterranean formations 118.

Drilling fluid 122 may be prepared. A pump 120, such as a mud pump, may circulate drilling fluid 122 through a feed pipe 124 and to the kelly 110, which conveys the drilling fluid 122 downhole through the interior of the drill string 108 and through one or more orifices in the drill bit 114. The drilling fluid 122 may then be circulated back to the surface via an annulus 126 defined between the drill string 108 and the walls of the wellbore 116. At the surface, the recirculated or spent drilling fluid 122 may exit the annulus 126 and may be conveyed to one or more fluid processing unit(s) 128 via an interconnecting flow line 130. The fluid processing unit(s) 128 may include, but may not limited to, one or more of a shaker, wherein the shaker may be a shale shaker, for example, a centrifuge, a hydrocyclone, a separator (e.g., magnetic and electrical separators), a desilter, a desander, a filter, wherein the filter may be a diatomaceous earth filter, for example, a heat exchanger, and/or any fluid reclamation equipment. The fluid processing unit(s) 128 may further include one or more sensors, gauges, pumps, compressors, and the like, used store, monitor, regulate, and/or recondition the drilling fluid 122.

After passing through the fluid processing unit(s) 128, a “cleaned” drilling fluid 122 may be deposited into a nearby retention pit 132, wherein the retention pit may be a mud pit, for example. While illustrated as being arranged at the outlet of the wellbore 116 via the annulus 126, those skilled in the art will readily appreciate that the fluid processing unit(s) 128 may be arranged at any other location in the drilling assembly 100 to facilitate its proper function, without departing from the scope of the disclosure. One or more of the drilling fluid additives may be added to the drilling fluid 122 via a mixing hopper 134 communicably coupled to or otherwise in fluid communication with the retention pit 132. The mixing hopper 134 may include, but is not limited to, mixers and related mixing equipment known to those skilled in the an. Alternatively, the drilling fluid additives may be added to the drilling fluid 122 at any other location in the drilling assembly 100. While FIG. 1 shows only a single retention pit 132, there may be more than one retention pit 132, such as multiple retention pits 132 in series. Moreover, the retention pit 132 may be representative of one or more fluid storage facilities and/or units where the drilling fluid additives may be stored, reconditioned, and/or regulated until being added to the drilling fluid 122.

The exemplary wellbore servicing fluids disclosed herein may directly or indirectly affect one or more components or pieces of equipment associated with the preparation, delivery, recapture, recycling, reuse, and/or disposal of the disclosed wellbore servicing fluids. For example, the disclosed wellbore servicing fluids may directly or indirectly affect one or more mixers, related mixing equipment, mud pits, storage facilities or units, composition separators, heat exchangers, sensors, gauges, pumps, compressors, and the like used generate, store, monitor, regulate, and/or recondition the exemplary wellbore servicing fluids. Moreover, the disclosed wellbore servicing fluids may also directly or indirectly affect any transport or delivery equipment used to convey the wellbore servicing fluids to a well site or downhole such as, for example, any transport vessels, conduits, pipelines, trucks, tubulars, and/or pipes used to compositionally move the wellbore servicing fluids from one location to another, any pumps, compressors, or motors, wherein the motors may be topside or downhole motors, for example, used to drive the wellbore servicing fluids into motion, any valves or related joints used to regulate the pressure or flow rate of the wellbore servicing fluids, and any sensors, such as pressure sensors or temperature sensors, gauges, and/or combinations thereof, and the like. The disclosed wellbore servicing fluids may also directly or indirectly affect the various downhole equipment and tools that may come into contact with the wellbore servicing fluids such as, but not limited to, wellbore casing, wellbore liner, completion string, insert strings, drill string, coiled tubing, slickline, wireline, drill pipe, drill collars, mud motors, downhole motors and/or pumps, cement pumps, surface-mounted motors and/or pumps, centralizers, turbolizers, scratchers, floats, such as shoes, collars, or valves, for example, logging tools and related telemetry equipment, actuators, such as electromechanical devices, for example, hydromechanical devices, etc.), sliding sleeves, production sleeves, plugs, screens, filters, flow control devices, such as inflow control devices, autonomous inflow control devices, or outflow control devices, for example, couplings, wherein the couplings may include electro-hydraulic wet connect, dry connect, or inductive coupler, for example, control lines, such as electrical lines, fiber optic lines, or hydraulic lines, for example, surveillance lines, drill bits and reamers, sensors or distributed sensors, downhole heat exchangers, valves and corresponding actuation devices, tool seals, packers, cement plugs, bridge plugs, and other wellbore isolation devices, or components, and the like.

In some aspects, the wellbore is extended through a salt dome. The disclosed wellbore servicing fluid may have particular advantages in drilling though certain subterranean formations such as salt domes. A salt dome is a diapir made of salt, commonly having an overlying cap rock. Salt domes form as a consequence of the relative buoyancy of salt when buried beneath other types of sediment, and hydrocarbons are commonly found around salt domes. There may exist several challenges to drilling salt domes including wellbore erosion and/or damage to the formation when drilling though the salt dome and/or though shales above or below the salt dome. Damage to the formation may include any range of damage from small amounts of washout or removal of wellbore surface material beyond the size of the drill bit up to and including wellbore collapse. For example, a challenge in extending a wellbore through a subterranean formation (e.g., a salt dome) including a relatively high amount of water-soluble species is that a water-based drilling fluid may solvate the soluble species and remove them from the formation and wellbore surface. The water-soluble species may then be moved from the wellbore as the drilling fluid flows back up to the wellbore surface. Salt domes may also cause catastrophic drilling fluid loss which may prevent the use of an oil-based drilling fluid or a synthetic-based drilling fluid. Loss of fluid to the salt dome may prevent additional penetration as cuttings may not be effectively removed and excessive bit wear from inadequate cooling. Loss of drilling fluid may be expensive as additional drilling fluid must be provided to make up for the loss. In offshore applications in particular, additional drilling fluid may not be readily available. Additional challenges exist in deep wells where the hydrostatic pressure from the drilling fluid may become higher than the fracture gradient of a subterranean formation leading to pre-mature fracturing of subterranean formation. As will be appreciated by one of ordinary skill in the art, these and other challenges may be met by the wellbore servicing fluid described herein. For example, the wellbore servicing fluid may reduce the amount of salt removed (e.g., salt washout) and/or the loss of fluid.

Also disclosed herein is a method of servicing a wellbore penetrating a subterranean formation. The method can include providing a wellbore servicing fluid including an aqueous fluid, an oil, and a compound according to Structure III:

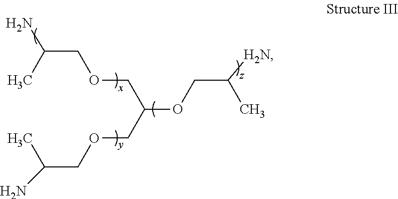

wherein x+y+z is about 85, and the compound has a molecular weight of from about 4,500 Da to about 5,500 Da. The method can further include circulating the wellbore servicing fluid from a surface, through a wellbore, and back to the surface; and extending the wellbore in the subterranean formation while circulating the wellbore servicing fluid. In some aspects, the aqueous fluid includes a brine, the oil includes a synthetic oil, and the wellbore is extended through a salt dome.

Various benefits may be realized by utilization of the presently disclosed methods and compositions. By incorporating the compound into the wellbore servicing fluid as disclosed herein, emulsion stability of the wellbore servicing fluid can be increased. The wellbore servicing fluid can have a reduced cost by reducing dilution and waste volume. The wellbore servicing fluid also has advantages in drilling though certain subterranean formations such as salt domes by reducing fluid loss and/or salt washout.

### EXAMPLES

The aspects having been generally described, the following examples are given as particular aspects of the disclosure and to demonstrate the practice and advantages thereof. It is understood that the examples are given by way of illustration and are not intended to limit the specification or the claims in any manner.

### Example 1

Four wellbore servicing fluid samples were prepared according to the formulation in Tables 1 and 2. The components were added in certain order and amounts to obtain concentrations (Conc.) in pounds per barrel (ppb) as in Tables 1 and 2. A current emulsifier that has been used in a drilling fluid was used in forming a blank/reference sample. Samples 1, 2, and 3 had the same compositions as the reference sample except that the current emulsifier was replaced with increasing amounts of the compound disclosed herein. The four samples had a density of 9 pounds per gallon (ppg).

After preparation, according to Table 1, a first portion of the reference sample and a first portion of sample 1 were each blended with a mixer (BHR Mixing in Table 1, where BHR stands for “before hot rolling”), and then underwent hot rolling at 160° F. for 16 hours, followed by dynamic aging. A second portion of the reference sample and a second portion of sample 1 underwent static aging at 160° F. for 24 hours and were then each blended with a mixer (AHR Mixing in Table 1, where AHR stands for “after hot rolling”).

TABLE 1
Formulation and properties for a 9 ppg wellbore servicing fluid with a current emulsifier and the compound

| Components in | | Time | | | | | | | | |
|---|---|---|---|---|---|---|---|---|---|---|
| order of addition | Conc. | (min) | Blank/Reference | | | | 1 | | | |
| 10 ppg brine | ppb | 2 | 272.58 | | | | 272.58 | | | |
| Salt | ppb | 2 | 0.3 | | | | 0.3 | | | |
| Viscosifier I | ppb | 10 | 0.75 | | | | 0.75 | | | |
| Filtration control agent | ppb | 5 | 4 | | | | 4 | | | |
| pH buffer | ppb | 2 | 1.5 | | | | 1.5 | | | |
| Viscosifier II | ppb | 5 | 8 | | | | 8 | | | |
| Fluid loss control agent | ppb | 3 | 1 | | | | 1 | | | |
| A current emulsifier | ppb | | 3 | | | | — | | | |
| The compound | ppb | | — | | | | 3 | | | |
| Oil | ppb | 30 | 87.36 | | | | 87.36 | | | |
| Mixing & Aging | | | | | | | | | | |
| Parameters | | | | | | | | | | |
| BHR Mixing (Mixer | | | Silverson ® | | — | | Silverson ® | | — | |
| Type & Speed) | | | mixer at 6000 | | | | mixer at 6000 | | | |
| | | | rpm for 15 min | | | | rpm for 15 min | | | |
| Mixed Volume | | | 2 | bbl | 1 | bbl | 2 | bbl | 1 | bbl |
| Roiling Temperature | | | 160° | F. | — | | 160° | F. | — | |
| Rolling Time | | | 16 | hr | — | | 16 | hr | — | |
| Static aging | | | — | | 160° | F. | — | | 160° | F. |
| temperature | | | | | | | | | | |
| Static aging time | | | — | | 24 | hr | — | | 24 | hr |
| Aging Condition | | | Dynamic | | Static | | Dynamic | | Static | |
| AHR Mixing | | | — | | Multimixer at | | — | | Multimixer at | |
| | | | | | 11500 rpm for | | | | 11500 rpm for | |
| | | | | | 10 min | | | | 10 min | |
| Properties | | Specs | | | | | | | | |
| Viscometer FANN ® | | | AHR | | ASA | | AHR | | ASA | |
| 35SA | | | | | | | | | | |
| Rheology at 120° F. | | | 120° | F. | 120° | F. | 120° | F. | 120° | F. |

| 600 rpm | | | 60 | 61 | 82 | 76 |
|---|---|---|---|---|---|---|
| 300 rpm | | | 38 | 39 | 61 | 58 |
| 200 rpm | | | 29 | 30 | 51 | 49 |
| 100 rpm | | | 20 | 20 | 38 | 36 |
| 6 rpm | | >10 | 7 | 7 | 11 | 10 |
| 3 rpm | | | 6 | 5 | 8 | 8 |
| PV | cP | ALAP | 22 | 22 | 21 | 18 |
| YP | lbs/100 ft² | 25-30 | 16 | 17 | 40 | 40 |
| 10 sec gel strength | lbs/100 ft² | | 8 | 7 | 9 | 9 |
| 10 min gel strength | lbs/100 ft² | | 9 | 8 | 11 | 11 |
| pH | | | 9.01 | 9.29 | 9.41 | 9.49 |
| API Fluid loss | | | | | | |
| 30 min FL (total) | | <5 | 5 | | 5 | |
| Oil in filtrate, mL | | | 1.8 | | 0.8 | |
| Sag Testing | | | | | | |
| Top oil separation, ml | | | | 8.5 | | 0.5 |
| Top oil separation, % | | | | 2.43 | | 0.143 |
| Top SG | | | | 0.997 | | 1.07 |
| Bottom SG | | | | 1.147 | | 1.112 |
| Sag Factor | | | | 0.5349 | | 0.5104 |

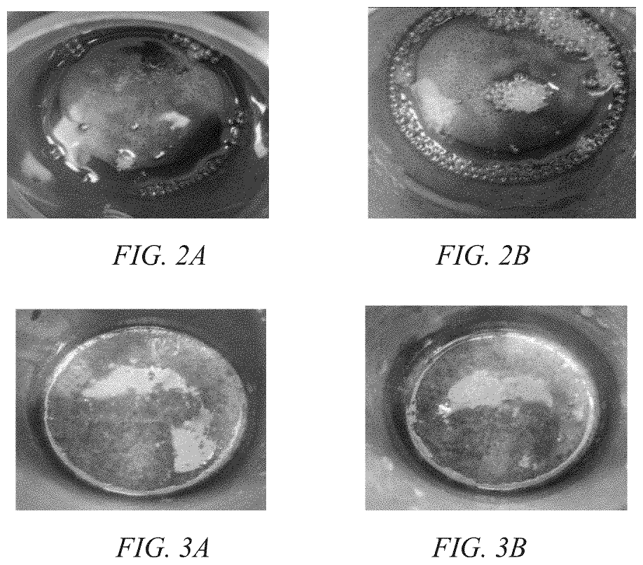

After preparation, according to Table 2, a first portion of sample 2 and a first portion of sample 3 were each blended with a mixer (BHR Mixing in Table 2), measured for properties including rheology, plastic viscosity (PV), yield point (YP), 10-second gel strength, 10-minute gel strength, and pH, and then underwent hot rolling at 160° F. for 16 hours, followed by dynamic aging, and were then each blended with a Silverson® mixer (AHR Mixing in Table 2). After shearing on the Silverson® mixer for 15 minutes (AHR Mixing in Table 2) each of the first portions of samples 2 and 3 was homogeneous. A second portion of sample 2 and a second portion of sample 3 underwent static aging at 160° F. for 24 hours, and were then each blended with a Multimixer mixer (AHR Mixing in Table 2). FIGS. 2A and 2B are photos of samples 2 and 3 after hot rolling and show complete oil separation, respectively. FIGS. 3A and 3B are photos of samples 2 and 3 after static aging (ASA) and show no top oil separation.

TABLE 2
Formulation and properties for a 9 ppg wellbore servicing fluid with increasing concentration of the compound

| Components in | | Time | | | | | | | | | | |
|---|---|---|---|---|---|---|---|---|---|---|---|---|
| order of addition | Conc. | (min) | Blank/Reference | | | | | 1 | | | | |
| 10 ppg brine | ppb | 2 | 272.58 | | | | | 272.58 | | | | |
| Salt | ppb | 2 | 0.3 | | | | | 0.3 | | | | |
| Viscosifier I | ppb | 10 | 0.75 | | | | | 0.75 | | | | |
| Filtration | ppb | 5 | 4 | | | | | 4 | | | | |
| control agent | | | | | | | | | | | | |
| pH buffer | ppb | 2 | 1.5 | | | | | 1.5 | | | | |
| Viscosifier II | ppb | 5 | 8 | | | | | 8 | | | | |
| Fluid loss | ppb | 3 | 1 | | | | | 1 | | | | |
| control agent | | | | | | | | | | | | |
| The | ppb | 1 | 0.5 | | | | | 1.5 | | | | |
| compound | | | | | | | | | | | | |
| Oil | ppb | 30 | 87.36 | | | | | 87.36 | | | | |
| Mixing & | | | | | | | | | | | | |
| Aging | | | | | | | | | | | | |
| Parameters | | | | | | | | | | | | |
| BHR Mixing | | | Multimixer at 11500 rpm | | | | | Multimixer at 11500 rpm | | | | |
| (Mixer Type & | | | | | | | | | | | | |
| Speed) | | | | | | | | | | | | |
| Mixed Volume | | | 1 bbl | | | | | 1 bbl | | | | |
| Rolling | | | | 160° | F. | | | | 160° | F. | | |
| Temperature | | | | | | | | | | | | |
| Rolling Time | | | | 16 | hr | | | | 16 | hr | | |
| Static aging | | | | | | 160° | F. | | | | 160° | F. |
| temperature | | | | | | | | | | | | |
| Static aging | | | | | | 24 | hrs | | | | 24 | hrs |
| time | | | | | | | | | | | | |
| Aging | | | | Dynamic | | Static | | | Dynamic | | Static | |
| Condition | | | | | | | | | | | | |
| AHR Mixing | | | | Silverson ® | | Multimixer at | | | Silverson ® | | Multimixer at | |
| | | | | mixer at | | 11500 rpm | | | mixer at | | 11500 rpm | |
| | | | | 6000 rpm | | for 10 min | | | 6000 rpm | | for 10 min | |
| | | | | for 15 min | | | | | for 15 min | | | |
| Properties | | Specs | | | | | | | | | | |
| Viscometer | | | BHR | AHR | | ASA | | BHR | AHR | | ASA | |
| FANN ® 35SA | | | | | | | | | | | | |
| Rheology at | | | 120° F. | 120° | F. | 120° | F. | 120° F. | 120° | F. | 120° | F. |
| 120° F. | | | | | | | | | | | | |

| 600 rpm | | | 51 | 67 | 72 | 54 | 65 | 69 |
|---|---|---|---|---|---|---|---|---|
| 300 rpm | | | 35 | 49 | 55 | 38 | 47 | 51 |
| 200 rpm | | | 28 | 40 | 46 | 31 | 39 | 43 |
| 100 rpm | | | 21 | 29 | 33 | 22 | 28 | 32 |
| 6 rpm | | >10 | 6 | 9 | 9 | 6 | 8 | 9 |
| 3 rpm | | | 5 | 7 | 6 | 5 | 6 | 7 |
| PV | cP | ALAP | 16 | 18 | 17 | 16 | 18 | 18 |
| YR | lbs/100 ft² | 25-30 | 19 | 31 | 38 | 22 | 29 | 33 |
| 10 sec gel | lbs/100 ft² | | 7 | 8 | 8 | 7 | 8 | 9 |
| strength | | | | | | | | |
| 10 min gel | lbs/100 ft² | | — | 10 | 9 | — | 9 | 10 |
| strength | | | | | | | | |
| pH | | | 9.82 | 9.65 | 9.48 | 9.83 | 9.54 | 9.42 |
| API Fluid loss | | | | | | | | |
| 30 min FL | | <5 | | 6.2 | | | 5 | |
| (total) | | | | | | | | |
| Oil in filtrate, | | | | 1.4 | | | 0.4 | |
| mL | | | | | | | | |
| Sag Testing | | | | | | | | |
| Top oil | | | | | 0 | | | 0 |
| separation, ml | | | | | | | | |
| Top oil | | | | | 0.00 | | | 0.00 |
| separation, % | | | | | | | | |
| Top SG | | | | | 1.039 | | | 1.06 |
| Bottom SG | | | | | 1.102 | | | 1.102 |
| Sag Factor | | | | | 0.5149 | | | 0.5096 |
| Remarks | | | | | | | | |

| | | |
|---|---|---|
| After hot | Complete oil separation | Complete oil separation |
| rolling | | |
| After shearing | Fluid homogeneous | Fluid homogeneous |
| on Silverson ® | after shearing on | after shearing on |
| mixer for 15 | Silverson ® mixer | Silverson ® mixer |
| minutes | | |
| After Static | No top oil separation | No top oil separation |
| aging | | |

Properties including rheology, plastic viscosity (PV), yield point (YP), 10-second gel strength, 10-minute gel strength, and pH were then measured for each of the portions of the reference sample and samples 1-3. API fluid loss test and a sag test were performed for the portions of samples undergone dynamic aging and static aging, respectively. The results in Tables 1 and 2 demonstrated that the compound in this disclosure could perform as an emulsifier for the wellbore servicing fluid samples 1-3. Rheology readings at 3 and 6 rpm and yield points of samples 1-3 were equal to or greater than that of the reference sample, respectively. Volumes of oil in the API filtrate (i.e., filtrate volume in term of ml after 30 minutes in an API fluid loss (FL) test) of samples 1-3 were less than that of the reference sample. Volumes and percentages of the top oil separation of samples 1-3 were less than that of the reference sample, respectively. Samples 1-3 each had a sag factor less than the reference sample. The specification for the plastic viscosity is as low as possible (ALAP). Table 3 is a summary of the comparison discussed above.

TABLE 3
Comparison of fluid properties with a current emulsifier and increasing cone. of the compound

| | Reference sample | 0.5 ppb | 1.5 ppb | 3 ppb |
|---|---|---|---|---|
| | with a current | of the | of the | of the |
| Properties | emulsifier | compound | compound | compound |
| 6 rpm | 7 | 9 | 8 | 11 |
| 3 rpm | 6 | 7 | 6 | 8 |
| PV, cP | 22 | 18 | 18 | 21 |
| YP, lb/100 ft² | 16 | 31 | 29 | 40 |
| Top oil | 8.5 | 0 | 0 | 0.5 |
| separation, ml | | | | |
| after 24 hrs | | | | |
| static Aging | | | | |
| API fluid loss, ml | 5 | 6.2 | 5 | 5 |
| Sag Factor | 0.5349 | 0.5149 | 0.5096 | 0.5104 |

### Additional Disclosure

The following is provided as additional disclosure for combinations of features and embodiments of the present disclosure.

A first embodiment, which is a wellbore servicing fluid comprising: an aqueous fluid, an oil, and a compound according to Structure I or Structure II:

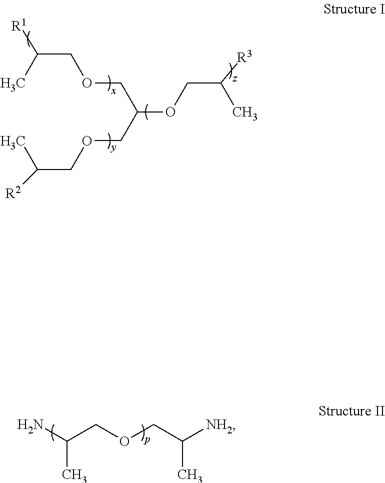

wherein R¹, R², and R³ are independently selected from the group including —NH₂, —NR⁷R⁸, —H, —OH, halo, straight or branched (C₁-C₆)alkyl, straight or branched (C₂-C₆)alkenyl, straight or branched (C₂-C₆)alkynyl, (C₆-C₁₄)aryl, (C₃-C₁₄)-cycloalkyl, (C₆-C₁₄)aryl-(C₁-C₆)alkylene-, (5-14-membered)heteroaryl-(C₁-C₆)alkylene-, (5-14-membered)heteroaryl, (3-14-membered)heterocycloalkyl, (3-14-membered)heterocycloalkyl-(C₁-C₆)alkylene-, (5-14-membered)heteroaryl-(3-14-membered)heterocycloalkylene-, (C₆-C₁₄)aryl-(3-14-membered)heterocycloalkylene-, (C₆-C₁₄)aryl-(C₁-C₆)alkyl-(3-14-membered)heterocycloalkylene-, (5-14-membered)heteroaryl-(C₁-C₆)alkyl-(3-14-membered)heterocycloalkylene-, and (3-14-membered)heterocycloalkyl-(C₁-C₆)alkyl-(3-14-membered)heterocycloalkylene-; wherein at least one of R¹, R², and R³ is —NH₂; wherein R⁷ and R⁸ are independently selected from the group including straight or branched (C₁-C₆)alkyl, straight or branched (C₂-C₆)alkenyl, straight or branched (C₂-C₆)alkynyl, (C₆-C₁₄)aryl, (C₃-C₁₄)-cycloalkyl, (C₆-C₁₄)aryl-(C₁-C₆)alkylene-, (5-14-membered)heteroaryl-(C₁-C₆)alkylene-, (5-14-membered)heteroaryl, (3-14-membered)heterocycloalkyl, (3-14-membered)heterocycloalkyl-(C₁-C₆)alkylene-, (5-14-membered)heteroaryl-(3-14-membered)heterocycloalkylene-, (C₆-C₁₄)aryl-(3-14-membered)heterocycloalkylene-, (C₆-C₁₄)aryl-(C₁-C₆)alkyl-(3-14-membered)heterocycloalkylene-, (5-14-membered)heteroaryl-(C₁-C₆)alkyl-(3-14-membered)heterocycloalkylene-, and (3-14-membered)heterocycloalkyl-(C₁-C₆)alkyl-(3-14-membered)heterocycloalkylene-; wherein x+y+z is from about 70 to about 100; and wherein the compound of structure II has a molecular weight of from about 220 Dalton (Da) to about 2,000 Da.

A second embodiment, which is the wellbore servicing fluid of the first embodiment, wherein each of R¹, R², and R³ is —NH₂, and wherein x+y+z is about 85.

A third embodiment, which is the wellbore servicing fluid of the first or the second embodiment, wherein the compound of structure I has a molecular weight of from about 4,000 Da to about 6,000 Da.

A fourth embodiment, which is the wellbore servicing fluid of any of the first through the third embodiments, wherein the compound of structure I has a molecular weight of from about 4,500 Da to about 5,500 Da.

A fifth embodiment, which is the wellbore servicing fluid of any of the first through the fourth embodiments, wherein p is from about 3 to about 40.

A sixth embodiment, which is the wellbore servicing fluid of any of the first through the fifth embodiments, wherein the compound is present in the wellbore servicing fluid in an amount of from about 0.5 pounds per barrel (ppb) to about 10 ppb.

A seventh embodiment, which is the wellbore servicing fluid of any of the first through the sixth embodiments, wherein the oil is selected from the group consisting of alkanes, olefins, alkynes, aromatics, tall oil, crude oil, light cycle oil, synthetic ester oil, diesel, cycloalkane, liquefied petroleum gas, kerosene, gas oil, fuel oil, paraffin oil, mineral oil, refined oil, low-toxicity mineral oil, ester, amide, synthetic oil, polydiorganosiloxane, siloxane, organosiloxane, ether, dialkylcarbonate, vegetable oil, biodiesel, renewable diesel, and combinations thereof.

An eighth embodiment, which is the wellbore servicing fluid of any of the first through the seventh embodiments, wherein the oil comprises a synthetic oil.

A ninth embodiment, which is the wellbore servicing fluid of any of the first through the eighth embodiments, wherein the oil is present in the wellbore servicing fluid in an amount of from about 1 vol. % to about 40 vol. %, based on a total volume of the wellbore servicing fluid.

A tenth embodiment, which is the wellbore servicing fluid of any of the first through the ninth embodiments, wherein the aqueous fluid comprises fresh water, surface water, ground water, salt water, brine, sea water, produced water, or combinations thereof.

An eleventh embodiment, which is the wellbore servicing fluid of any of the first through the tenth embodiments, wherein the aqueous fluid comprises a brine.

A twelfth embodiment, which is the wellbore servicing fluid of any of the tenth through the eleventh embodiments, wherein the brine comprises monovalent or divalent salts, wherein the salts comprise at least one salt selected from the group consisting of sodium chloride, sodium bromide, potassium bromide, potassium chloride, magnesium chloride, calcium chloride, calcium bromide, potassium formate, cesium formate, lithium chloride, lithium bromide, sodium formate, lithium formate, ammonium chloride, tetramethyl ammonium chloride, choline chloride, potassium acetate, and combinations thereof.

A thirteenth embodiment, which is the wellbore servicing fluid of any of the tenth through the twelfth embodiments, wherein the brine is a saturated brine.

A fourteenth embodiment, which is the wellbore servicing fluid of any of the first through the thirteenth embodiments, wherein the aqueous fluid is present in the wellbore servicing fluid in an amount of from about 50 vol. % to about 99 vol. % based on the total volume of the wellbore servicing fluid.

A fifteenth embodiment, which is the wellbore servicing fluid of any of the first through the fourteenth embodiments, having a volume ratio of the oil to the aqueous fluid of from about 90:10 to about 20:80.

A sixteenth embodiment, which is the wellbore servicing fluid of any of the first through the fifteenth embodiments, further comprising a viscosifier.

A seventeenth embodiment, which is the wellbore servicing fluid of the sixteenth embodiment, wherein the viscosifier comprises a biopolymer, a synthetic polymer, minerals, or a combination thereof.

An eighteenth embodiment, which is the wellbore servicing fluid of the sixteenth or the seventeenth embodiment, wherein the viscosifier comprises hydroxyethyl cellulose, hydroxy-propyl guar, carboxy-methyl-hydroxy-propyl guar, modified polysaccharides, partially hydrolyzed polyacrylamide (PHPA), carboxy-methylcellulose, polyanionic cellulose, guar gum, locust bean gum, Karaya gum, gum tragacanth, hydrophobically modified guars, high-molecular weight polysaccharides composed of mannose and galactose sugars, heteropolysaccharides obtained by the fermentation of starch-derived sugars, xanthan, pectins, diutan, welan, gellan, scleroglucan, chitosan, dextran, substituted or unsubstituted galactomannans, starch, cellulose, cellulose ethers, carboxycelluloses, hydroxypropyl cellulose, carboxyalkylhydroxyethyl celluloses, carboxymethyl hydroxyethyl cellulose, methyl cellulose, sodium polyacrylate, polyacrylamide, partially hydrolyzed polyacrylamide, polymethacrylamide, poly(acrylamido-2-methyl-propane sulfonate), poly(sodium-2-acrylamide-3-propylsulfonate), copolymers of acrylamide and acrylamido-2-methyl-propane sulfonate, terpolymers of acrylamido-2-methyl-propane sulfonate, acrylamide and vinylpyrrolidone or itaconic acid, sepiolite, attapulgite, or combinations thereof.

A nineteenth embodiment, which is the wellbore servicing fluid of any of the sixteenth through the eighteenth embodiments, wherein the viscosifier has a molecular weight in a range of from about 1.2 MM Da to about 5 MM Da.

A twentieth embodiment, which is the wellbore servicing fluid of any of the sixteenth through the nineteenth embodiments, wherein the viscosifier is in the wellbore servicing fluid in an amount of from about 0.001 wt. % to about 3 wt. %, based on the total weight of the wellbore servicing fluid.

A twenty-first embodiment, which is the wellbore servicing fluid of any of the first through the twentieth embodiments, further comprising one or more additives.

A twenty-second embodiment, which is the wellbore servicing fluid of the twenty-first embodiment, wherein the one or more additives comprise a rate of penetration enhancer, spotting fluid, a sweeping agent, a deflocculant, a degreaser, a pH buffer, a wetting agent, a lubricant, a shale inhibitor, a friction reducer, a strength-stabilizing agent, an emulsifier, an expansion agent, a salt, a fluid loss agent, a vitrified shale, a thixotropic agent, a dispersing agent, a weight reducing additive, a heavyweight additive, a surfactant, a scale inhibitor, a clay stabilizer, a silicate-control agent, a biocide, a biostatic agent, a storage stabilizer, a filtration control additive, a suspending agent, a foaming surfactant, latex emulsions, a formation conditioning agent, elastomers, gas/fluid absorbing materials, resins, superabsorbers, mechanical property modifying additives, inert particulates, a biopolymer, a polymer, a fume silica, a free fluid control additive, particulate materials, acids, bases, mutual solvents, corrosion inhibitors, conventional breaking agents, relative permeability modifiers, lime, clay control agents, fluid loss control additives, flocculants, water softeners, foaming agents, oxidation inhibitors, thinners, scavengers, gas scavengers, lubricants, bridging agents, a foam stabilizer, catalysts, dispersants, breakers, emulsion thinner, emulsion thickener, pH control additive, lost circulation additives, buffers, stabilizers, chelating agents, oxidizers, a clay, reducers, consolidating agent, complexing agent, sequestration agent, control agent, an oxidative breaker, and the like, or combinations thereof.

A twenty-third embodiment, which is the wellbore servicing fluid of the twenty-first or the twenty-second embodiment, wherein the one or more additives are present in the wellbore servicing fluid in an amount of from about 0.001 wt. % to about 50 wt. % based on the total weight of the wellbore servicing fluid.

A twenty-fourth embodiment, which is the wellbore servicing fluid of any of the first through the twenty-third embodiments, having a plastic viscosity of from about 1 cP to about 80 cP at about 120° F.

A twenty-fifth embodiment, which is the wellbore servicing fluid of any of the first through the twenty-fourth embodiments, having a yield point of from about 1 lbs/100 ft² to about 100 lbs/100 ft² at about 30° F. to about 180° F.

A twenty-sixth embodiment, which is the wellbore servicing fluid of any of the first through the twenty-fifth embodiments, having a 10-second gel strength of from about 1 lbf/100 ft² to about 50 lbf/100 ft² at about 30° F. to about 180° F.

A twenty-seventh embodiment, which is the wellbore servicing fluid of any of the first through the twenty-sixth embodiments, having a 10-minite gel strength of from about 1 lbf/100 ft² to about 50 lbf/100 ft² at about 30° F. to about 180° F.

A twenty-eighth embodiment, which is the wellbore servicing fluid of any of the first through the twenty-seventh embodiments, having a pH of from about 7 to about 11.

A twenty-ninth embodiment, which is the wellbore servicing fluid of any of the first through the twenty-eighth embodiments, having a total fluid loss of from about 0 mL to about 20 mL per 30 minutes, when measured in accordance with test standard API-RP-10B-2.

A thirtieth embodiment, which is the wellbore servicing fluid of the twenty-ninth embodiment, wherein the total fluid loss comprises an oil layer in an amount of from about 0 mL to about 10 mL per 30 minutes.

A thirty-first embodiment, which is the wellbore servicing fluid of any of the first through the thirtieth embodiments, having a rheology reading of from about 3 to about 200 at about 120° F. to about 150° F., atmospheric pressure, and 3 rpm to 600 rpm, when measured in accordance with test standard API-RP-10B-2 before hot rolling, after hot rolling at about 160° F. for about 16 hours to about 24 hours, and after static aging at about 160° F. for about 24 hours.

A thirty-second embodiment, which is the wellbore servicing fluid of any of the first through the thirty-first embodiments, having a rheology reading of from about 3 to about 20 at about 120° F. to about 150° F., atmospheric pressure, and 3 rpm to 6 rpm, when measured in accordance with test standard API-RP-10B-2 before hot rolling, after hot rolling at about 160° F. for about 16 hours to about 24 hours, and after static aging at about 160° F. for about 24 hours.

A thirty-third embodiment, which is the wellbore servicing fluid of any of the first through the thirty-second embodiments, having a sag factor of from about 0.50 to about 0.53, when measured in accordance with test standard API-RP-13B-2.

A thirty-fourth embodiment, which is the wellbore servicing fluid of any of the first through the thirty-third embodiments, having a top oil separation of equal to or less than about 4% based on the total volume of the wellbore servicing fluid in a sag test after static aging for about 24 hours at about 160° F., when measured in accordance with test standard API-RP-13B-2.

A thirty-fifth embodiment, which is the wellbore servicing fluid of any of the first through the thirty-fourth embodiments, having a density of from about 4 lb/gal (ppg) to about 25 ppg.

A thirty-sixth embodiment, which is the wellbore servicing fluid of any of the first through the thirty-fifth embodiments, having an electrical stability reading of from about 0 volts to about 5 volts, when measured in accordance to test standard API-RP-13B-2.

A thirty-seventh embodiment, which is the wellbore servicing fluid of any of the first through the thirty-sixth embodiments, being a direct emulsion fluid.

A thirty-eighth embodiment, which is a method of preparing the wellbore servicing fluid of any of the first through the thirty-seventh embodiments, comprising: mixing components of the wellbore servicing fluid using mixing equipment to form a pumpable slurry.

A thirty-ninth embodiment, which is a method of servicing a wellbore penetrating a subterranean formation, comprising: providing a wellbore servicing fluid comprising an aqueous fluid, an oil, and a compound according to Structure I or Structure II:

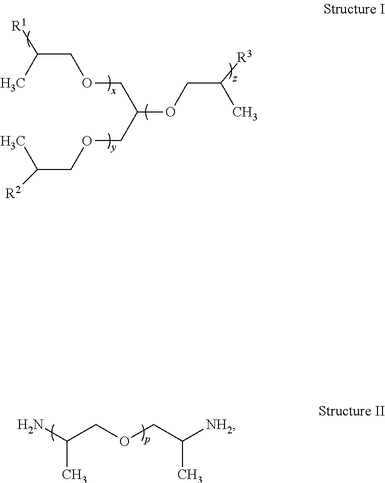

wherein R¹, R², and R³ are independently selected from the group including —NH₂, —NR⁷R⁸, —H, —OH, halo, straight or branched (C₁-C₆)alkyl, straight or branched (C₂-C₆)alkenyl, straight or branched (C₂-C₆)alkynyl, (C₆-C₁₄)aryl, (C₃-C₁₄)-cycloalkyl, (C₆-C₁₄)aryl-(C₁-C₆)alkylene-, (5-14-membered)heteroaryl-(C₁-C₆)alkylene-, (5-14-membered)heteroaryl, (3-14-membered)heterocycloalkyl, (3-14-membered)heterocycloalkyl-(C₁-C₆)alkylene-, (5-14-membered)heteroaryl-(3-14-membered)heterocycloalkylene-, (C₆-C₁₄)aryl-(3-14-membered)heterocycloalkylene-, (C₆-C₁₄)aryl-(C₁-C₆)alkyl-(3-14-membered)heterocycloalkylene-, (5-14-membered)heteroaryl-(C₁-C₆)alkyl-(3-14-membered)heterocycloalkylene-, and (3-14-membered)heterocycloalkyl-(C₁-C₆)alkyl-(3-14-membered)heterocycloalkylene-, wherein at least one of R¹, R², and R³ is —NH₂, wherein R⁷ and R⁸ are independently selected from the group including straight or branched (C₁-C₆)alkyl, straight or branched (C₂-C₆)alkenyl, straight or branched (C₂-C₆)alkynyl, (C₆-C₁₄)aryl, (C₃-C₁₄)-cycloalkyl, (C₆-C₁₄)aryl-(C₁-C₆)alkylene-, (5-14-membered)heteroaryl-(C₁-C₆)alkylene-, (5-14-membered)heteroaryl, (3-14-membered)heterocycloalkyl, (3-14-membered)heterocycloalkyl-(C₁-C₆)alkylene-, (5-14-membered)heteroaryl-(3-14-membered)heterocycloalkylene-, (C₆-C₁₄)aryl-(3-14-membered)heterocycloalkylene-, (C₆-C₁₄)aryl-(C₁-C₆)alkyl-(3-14-membered)heterocycloalkylene-, (5-14-membered)heteroaryl-(C₁-C₆)alkyl-(3-14-membered)heterocycloalkylene-, and (3-14-membered)heterocycloalkyl-(C₁-C₆)alkyl-(3-14-membered)heterocycloalkylene-, wherein x+y+z is from about 70 to about 100, and wherein the compound of structure II has a molecular weight of from about 220 Dalton (Da) to about 2,000 Da; circulating the wellbore servicing fluid from a surface, through a wellbore, and back to the surface; and extending the wellbore in the subterranean formation while circulating the wellbore servicing fluid.

A fortieth embodiment, which is the method of the thirty-ninth embodiment, wherein the circulating comprises exiting the wellbore servicing fluid through an annulus and circulating the wellbore servicing fluid to one or more fluid processing units, wherein the fluid processing units comprise at least one fluid processing unit selected from the group consisting of a shaker, a centrifuge, a hydrocyclone, a separator, a heat exchanger, fluid reclamation equipment, and combinations thereof.

A forty-first embodiment, which is the method of fortieth embodiment, further comprising depositing the wellbore servicing fluid into a retention pit, wherein the retention pit comprises a mud pit.

A forty-second embodiment, which is the method of any of the thirty-ninth through the forty-first embodiments, wherein the wellbore is extended through a salt dome.

A forty-third embodiment, which is the method of any of the thirty-ninth through the forty-second embodiments, wherein the wellbore has a Bottomhole Circulating Temperature (BHCT) of from about 50° F. to about 300° F.

A forty-fourth embodiment, which is a method of servicing a wellbore penetrating a subterranean formation, comprising: providing a wellbore servicing fluid comprising an aqueous fluid, an oil, and a compound according to Structure III:

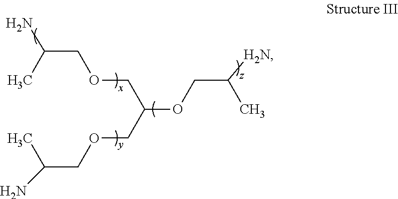

wherein x+y+z is about 85, and wherein the compound has a molecular weight of from about 4,500 Da to about 5,500 Da; circulating the wellbore servicing fluid from a surface, through a wellbore, and back to the surface; and extending the wellbore in the subterranean formation while circulating the wellbore servicing fluid.

A forty-fifth embodiment, which is the method of the forty-fourth embodiment, wherein the aqueous fluid comprises a brine, the oil comprises a synthetic oil, and the wellbore is extended through a salt dome.

While embodiments of the disclosure have been shown and described, modifications thereof can be made by one skilled in the art without departing from the spirit and teachings of the disclosure. The embodiments described herein are exemplary only, and are not intended to be limiting. Many variations and modifications of the disclosure disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L}, and an upper limit, R_{U}, is disclosed, any number falling within the range is specifically disclosed. In particular, the following numbers within the range are specifically disclosed: R=R_{L}+k*(R_{U}−R_{L}), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. When a feature is described as “optional,” both embodiments with this feature and embodiments without this feature are disclosed. Similarly, the present disclosure contemplates embodiments where this feature is required and embodiments where this feature is specifically excluded. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the embodiments of the present disclosure.

What is claimed is:

1. A wellbore servicing fluid comprising: an aqueous fluid, an oil, and a compound according to Structure I or Structure II: 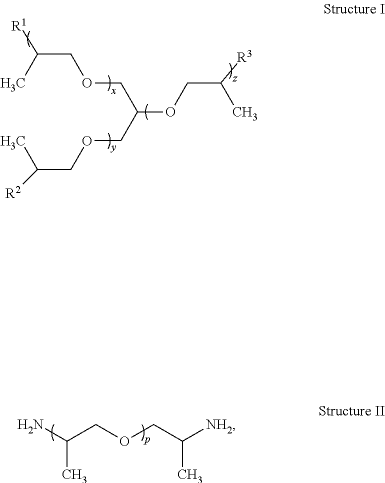
wherein R¹, R², and R³ are independently selected from the group including —NH₂, —NR⁷R⁸, —H, —OH, halo, straight or branched (C₁-C₆)alkyl, straight or branched (C₂-C₆)alkenyl, straight or branched (C₂-C₆)alkynyl, (C₆-C₁₄)aryl, (C₃-C₁₄)-cycloalkyl, (C₆-C₁₄)aryl-(C₁-C₆)alkylene-, (5-14-membered)heteroaryl-(C₁-C₆)alkylene-, (5-14-membered)heteroaryl, (3-14-membered)heterocycloalkyl, (3-14-membered)heterocycloalkyl-(C₁-C₆)alkylene-, (5-14-membered)heteroaryl-(3-14-membered)heterocycloalkylene-, (C₆-C₁₄)aryl-(3-14-membered)heterocycloalkylene-, (C₆-C₁₄)aryl-(C₁-C₆)alkyl-(3-14-membered)heterocycloalkylene-, (5-14-membered)heteroaryl-(C₁-C₆)alkyl-(3-14-membered)heterocycloalkylene-, and (3-14-membered)heterocycloalkyl-(C₁-C₆)alkyl-(3-14-membered)heterocycloalkylene-;
wherein at least one of R¹, R², and R³ is —NH₂;
wherein R⁷ and Rare independently selected from the group including straight or branched (C₁-C₆)alkyl, straight or branched (C₂-C₆)alkenyl, straight or branched (C₂-C₆)alkynyl, (C₆-C₁₄)aryl, (C₃-C₁₄)-cycloalkyl, (C₆-C₁₄)aryl-(C₁-C₆)alkylene-, (5-14-membered)heteroaryl-(C₁-C₆)alkylene-, (5-14-membered)heteroaryl, (3-14-membered)heterocycloalkyl, (3-14-membered)heterocycloalkyl-(C₁-C₆)alkylene-, (5-14-membered)heteroaryl-(3-14-membered)heterocycloalkylene-, (C₆-C₁₄)aryl-(3-14-membered)heterocycloalkylene-, (C₆-C₁₄)aryl-(C₁-C₆)alkyl-(3-14-membered)heterocycloalkylene-, (5-14-membered)heteroaryl-(C₁-C₆)alkyl-(3-14-membered)heterocycloalkylene-, and (3-14-membered)heterocycloalkyl-(C₁-C₆)alkyl-(3-14-membered)heterocycloalkylene-;
wherein x+y+z is from about 70 to about 100; and
wherein the compound of structure II has a molecular weight of from about 220 Dalton (Da) to about 2,000 Da.

2. The wellbore servicing fluid of claim 1, wherein each of R¹, R², and R³ is —NH₂, and wherein x+y+z is about 85.

3. The wellbore servicing fluid of claim 1, wherein the compound of structure I has a molecular weight of from about 4,000 Da to about 6,000 Da.

4. The wellbore servicing fluid of claim 1, wherein p is from about 3 to about 40.

5. The wellbore servicing fluid of claim 1, wherein the compound is present in the wellbore servicing fluid in an amount of from about 0.5 pounds per barrel (ppb) to about 10 ppb.

6. The wellbore servicing fluid of claim 1, wherein the oil is selected from the group consisting of alkanes, olefins, alkynes, aromatics, tall oil, crude oil, light cycle oil, synthetic ester oil, diesel, cycloalkane, liquefied petroleum gas, kerosene, gas oil, fuel oil, paraffin oil, mineral oil, refined oil, low-toxicity mineral oil, ester, amide, synthetic oil, polydiorganosiloxane, siloxane, organosiloxane, ether, dialkylcarbonate, vegetable oil, biodiesel, renewable diesel, and combinations thereof.

7. The wellbore servicing fluid of claim 1, having a volume ratio of the oil to the aqueous fluid of from about 90:10 to about 20:80.

8. The wellbore servicing fluid of claim 1, further comprising a viscosifier.

9. The wellbore servicing fluid of claim 1, having a total fluid loss of from about 0 mL to about 20 mL per 30 minutes, when measured in accordance with test standard API-RP-10B-2.

10. The wellbore servicing fluid of claim 9, wherein the total fluid loss comprises an oil layer in an amount of from about 0 mL to about 10 mL per 30 minutes.

11. The wellbore servicing fluid of claim 1, having a rheology reading of from about 3 to about 200 at about 120° F. to about 150° F., atmospheric pressure, and 3 rpm to 600 rpm, when measured in accordance with test standard API-RP-10B-2 before hot rolling, after hot rolling at about 160° F. for about 16 hours to about 24 hours, and after static aging at about 160° F. for about 24 hours.

12. The wellbore servicing fluid of claim 1, having a rheology reading of from about 3 to about 20 at about 120° F. to about 150° F., atmospheric pressure, and 3 rpm to 6 rpm, when measured in accordance with test standard API-RP-10B-2 before hot rolling, after hot rolling at about 160° F. for about 16 hours to about 24 hours, and after static aging at about 160° F. for about 24 hours.

13. The wellbore servicing fluid of claim 1, having a sag factor of from about 0.50 to about 0.53, when measured in accordance with test standard API-RP-13B-2.

14. The wellbore servicing fluid of claim 1, having a top oil separation of equal to or less than about 4% based on the total volume of the wellbore servicing fluid in a sag test after static aging for about 24 hours at about 160° F., when measured in accordance with test standard API-RP-13B-2.

15. The wellbore servicing fluid of claim 1, having an electrical stability reading of from about 0 volts to about 5 volts, when measured in accordance to test standard API-RP-13B-2.

16. The wellbore servicing fluid of claim 1, being a direct emulsion fluid.

17. A method of servicing a wellbore penetrating a subterranean formation, comprising:
providing a wellbore servicing fluid comprising an aqueous fluid, an oil, and a compound according to Structure I or Structure II: 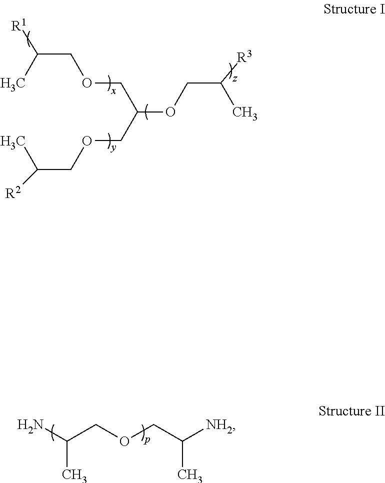
wherein R¹, R², and R³ are independently selected from the group including —NH₂, —NR⁷R⁸, —H, —OH, halo, straight or branched (C₁-C₆)alkyl, straight or branched (C₂-C₆)alkenyl, straight or branched (C₂-C₆)alkynyl, (C₆-C₁₄)aryl, (C₃-C₁₄)-cycloalkyl, (C₆-C₁₄)aryl-(C₁-C₆)alkylene-, (5-14-membered)heteroaryl-(C₁-C₆)alkylene-, (5-14-membered)heteroaryl, (3-14-membered)heterocycloalkyl, (3-14-membered)heterocycloalkyl-(C₁-C₆)alkylene-, (5-14-membered)heteroaryl-(3-14-membered)heterocycloalkylene-, (C₆-C₁₄)aryl-(3-14-membered)heterocycloalkylene-, (C₆-C₁₄)aryl-(C₁-C₆)alkyl-(3-14-membered)heterocycloalkylene-, (5-14-membered)heteroaryl-(C₁-C₆)alkyl-(3-14-membered)heterocycloalkylene-, and (3-14-membered)heterocycloalkyl-(C₁-C₆)alkyl-(3-14-membered)heterocycloalkylene-,
wherein at least one of R¹, R², and R³ is —NH₂,
wherein R⁷ and R⁸ are independently selected from the group including straight or branched (C₁-C₆)alkyl, straight or branched (C₂-C₆)alkenyl, straight or branched (C₂-C₆)alkynyl, (C₆-C₁₄)aryl, (C₃-C₁₄)-cycloalkyl, (C₆-C₁₄)aryl-(C₁-C₆)alkylene-, (5-14-membered)heteroaryl-(C₁-C₆)alkylene-, (5-14-membered)heteroaryl, (3-14-membered)heterocycloalkyl, (3-14-membered)heterocycloalkyl-(C₁-C₆)alkylene-, (5-14-membered)heteroaryl-(3-14-membered)heterocycloalkylene-, (C₆-C₁₄)aryl-(3-14-membered)heterocycloalkylene-, (C₆-C₁₄)aryl-(C₁-C₆)alkyl-(3-14-membered)heterocycloalkylene-, (5-14-membered)heteroaryl-(C₁-C₆)alkyl-(3-14-membered)heterocycloalkylene-, and (3-14-membered)heterocycloalkyl-(C₁-C₆)alkyl-(3-14-membered)heterocycloalkylene-,
wherein x+y+z is from about 70 to about 100, and
wherein the compound of structure II has a molecular weight of from about 220 Dalton (Da) to about 2,000 Da;
circulating the wellbore servicing fluid from a surface, through a wellbore, and back to the surface; and
extending the wellbore in the subterranean formation while circulating the wellbore servicing fluid.

18. The method of claim 17, wherein the circulating comprises exiting the wellbore servicing fluid through an annulus and circulating the wellbore servicing fluid to one or more fluid processing units, wherein the fluid processing units comprise at least one fluid processing unit selected from the group consisting of a shaker, a centrifuge, a hydrocyclone, a separator, a heat exchanger, fluid reclamation equipment, and combinations thereof.

19. The method of claim 17, wherein the wellbore is extended through a salt dome.

20. The method of claim 17, wherein the wellbore has a Bottomhole Circulating Temperature (BHCT) of from about 50° F. to about 300° F.
